(19) United States
(12) Patent Application Publication
(10) Pub. No.: US 2012/0119672 A1
(43) Pub. Date: May 17, 2012

(54) Snow Shield for a Traffic Signal Light

(76) Inventor: Gary Meyer, N. Hawthorn Woods, IL (US)

(21) Appl. No.: 12/945,051

(22) Filed: Nov. 12, 2010

(51) Int. Cl. H05B 37/02; F21V 5/00

(52) U.S. Cl. 315/294; 362/326

(57) ABSTRACT

The present invention is a snow deflecting LED traffic signal light apparatus with a The present invention is a snow deflecting LED traffic signal light apparatus having a dome shaped lens with an arc length that is proportionate to the arc length of a LED traffic signal light refracting lens and an encircling rim which has an inner diameter greater than the outer diameter of an LED traffic signal light visor. The apparatus may be affixed to existing LED traffic signal lights by a plurality of attachment members adapted to engage the visor of LED traffic signal lights.

### FIELD OF INVENTION

The present invention relates to the field of traffic safety devices, and more specifically to a snow shield designed to prevent snow build-up on LED traffic signal lights.

### BRIEF DESCRIPTION OF THE DRAWINGS

FIG. 1 is an exemplary embodiment of an unassembled snow deflecting traffic signal light apparatus.

FIG. 2 illustrates an alternative exemplary embodiment of an unassembled snow deflecting traffic signal light apparatus for use on traffic signal lights with a cutaway visor.

FIG. 3 is a bottom view of an exemplary embodiment of a snow deflecting traffic signal light apparatus.

FIG. 4 is a front view of an exemplary embodiment of a snow deflecting traffic signal light apparatus.

FIG. 5 is a side view of an exemplary embodiment of a snow deflecting traffic signal light apparatus.

FIG. 6 is a sectional view of exemplary embodiment of a snow deflecting traffic signal light apparatus not connected to a traffic signal light assembly.

### GLOSSARY

As used herein, the term “arc length” or “α” refers to a measurement calculated by the equation:

$$Arc Length = R ( \frac{2 π C}{360} ) ,$$

where C is the central angle of the arc of a lens in degrees, R is the radius of the arc of a lens, and π is Pi, approximately 3.142. A central angle may be determined by taking any angle whose vertex is the center of a circle, and whose sides pass through a pair of points on the circle.

As used herein, the term “LED” means a light emitting diode or group of light emitting diodes adapted for use in a traffic signal light, but also includes any light known in the art which emits insufficient heat to dissipate accumulations of snow.

As used herein, the term “LED traffic signal light module” is a self contained unit which produces and refracts light emitted from an LED light source to provide a traffic signal. An LED traffic signal light module may include a power source.

As used herein, the term “refracting lens” refers to any lens which directly covering the LEDs inside an LED traffic signal light module.

As used herein, the term “snow” refers to snow, ice sleet and other debris which may accumulate on a traffic signal light and lower the visibility of the light. For example, snow may include sleet, rain, hail, ice, volcanic ash, sand, dust, small particulate matter, leaves and other debris capable of accumulating on a traffic signal light.

As used herein, the term “ventilating opening” refers to any void in a traffic signal light visor that may provide ventilation to the LEDs or other operational components of an LED traffic signal light. Ventilating openings may be of any size or shape, including voids as small as slits or gaps, and including voids as big as half a visor or more.

As used herein, the term “visor” refers to any structure or appurtenance which extends to shield or partially shield a refracting lens. For example, a visor may provide a shield from weather, sun, moisture, snow and other elements which may affect the life or utility of a refracting lens.

As used herein, the term “12 inch visor” is any visor known in the art for complying with the Institute of Transportation Engineers' (ITE) standards and Vehicle Traffic Control Signal Heads (VTCSH) LED Circular Supplement.

As used herein, the term “12 inch LED lens” is any lens known in the art for complying with the Institute of Transportation Engineers' (ITE) standards and Vehicle Traffic Control Signal Heads (VTCSH) LED Circular Supplement.

### BACKGROUND

LED traffic signal lights have become standard in many cities around the United States, supplanting the use of other types of lighting such as incandescent style traffic signal lights. Prior traffic signal light designs used approximately 135 Watts, where LED designs use only 9 Watts, resulting in up to a 90% power savings. The power savings is primarily due to the ability of the LED light to produce light while generating minimal heat. Heat is dissipated as wasted energy. In addition to lower operational costs, LED traffic signal lights are more easily visible in sunlight, fog and heavy rain.

However, LED traffic signal lights have been problematic in winter environments and, in particular, snow storms. Unlike incandescent bulbs, the heat generated by the LED traffic signal lights is not sufficient to melt snow buildup on the traffic signal lights. LEDs do not generate heat in amounts able to melt snow, resulting in lower visibility, or sometimes zero visibility, of traffic signal lights.

Attempts have been made to design a shield or other device to either prevent snow buildup or trap heat to melt snow buildup. However, in order for a shield design to be implemented, it must meet with the guidelines set forth in the Manual on Uniform Traffic Control Devices (MUTCD). Shields cannot change the color or visibility of a traffic signal light, and cannot interfere with a driver's visibility of either the light or the area around the traffic signal light and intersection.

Some light shields have been developed that do conform to the MUTCD; however, these devices do not completely resolve the issue of snow buildup while maintaining the efficiency provided by LED traffic signal lights. For example, U.S. Pat. No. D580,092S discloses a fully enclosed dome shield device to installed over traffic signal lights that reduces that amount of snow and ice buildup. The shield operates by providing a slick surface meant to repel snow and a closed shield to trap the little heat generated by LEDs.

One problem associated with a fully enclosed dome shield devices is that moisture develops within the unit. The temperature differential created by trapping heat within the unit may cause moisture to develop and accumulate on the inside of the dome shield. The condensed moisture impacts visibility by changing the refraction qualities of the lens and may eventually hinder visibility of the traffic signal light all together as mineral deposits and other residue deposits build-up on the interior of the shield.

Moisture may also condense against the LEDs and other electrical components exposed within the shield. Moisture is known to shorten the life span of LEDs, and will likely cause damage to any other exposed components.

Further, heat is detrimental to LEDs. Fully enclosed dome shields trap what little heat LEDs give off, as well as heat from the environment, and do not allow ventilation. Prolonged exposure to heat shortens the life span of LEDs and may also damage other temperature-sensitive components of LED traffic signal lights.

Other devices known in the art provide a specially-shaped lens the fits within a traffic signal light's preexisting tunnel or visor. These devices may prevent snow from accumulating directly on the lens of the LED light, but still do not prevent buildup inside the tunnel visor.

It is desirable to create an easy to install snow deflecting LED traffic signal light apparatus that may be retrofit to existing LED traffic signal light visors.

It is desirable to create a snow deflecting LED traffic signal light apparatus that does not impact the life expectancy of LEDs.

It is desirable to create a snow deflecting LED traffic signal light apparatus that does not trap heat within the shield, against LEDs, and that provides ventilation for the traffic signal light unit.

### SUMMARY OF THE INVENTION

The present invention is a snow deflecting LED traffic signal light apparatus having a dome shaped lens with an arc length that is proportionate to the arc length of a LED traffic signal light refracting lens and an encircling rim which has an inner diameter greater than the outer diameter of an LED traffic signal light visor. The apparatus may be affixed to existing LED traffic signal lights by a plurality of attachment members adapted to engage the visor of LED traffic signal lights.

### DETAILED DESCRIPTION OF INVENTION

For the purpose of promoting an understanding of the present invention, references are made in the text to exemplary embodiments of a snow deflecting LED traffic signal light apparatus, only some of which are described herein. It should be understood that no limitations on the scope of the invention are intended by describing these exemplary embodiments. One of ordinary skill in the art will readily appreciate that alternate but functionally equivalent structures and materials may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

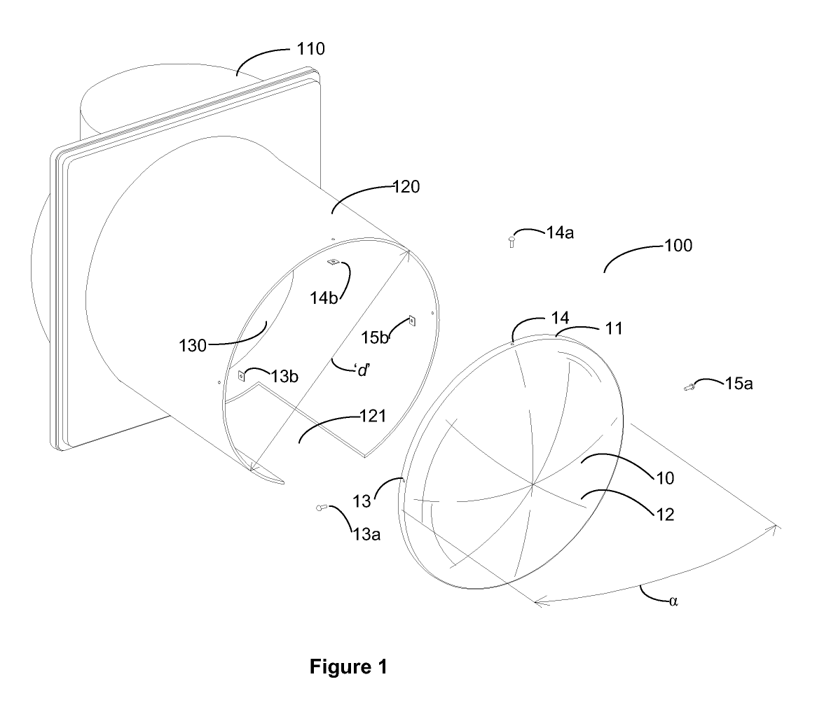

FIG. 1 illustrates an exemplary embodiment of snow deflecting traffic signal light apparatus 100. Traffic signal light assembly 110 is attached to traffic signal light visor 120, which in the embodiment shown is a tunnel visor. Traffic signal light assembly 110 may also include a power supply board (not shown) which converts 120 volts AC to 12 volts DC, because LEDs are designed to run on 12 volts DC. In further embodiments, power supply board (not shown) may be contained within a housing inside traffic signal light assembly.

Traffic signal light visor 120 protects refracting lens 130. In the embodiment shown, traffic signal light visor 120 further includes cutaway portion 121. Dome lens surface 10 has lens rim 11, which may contain attachment components. In the embodiment shown lens rim includes apertures 13, 14, 15 (not shown), which correspond to apertures in traffic signal light visor 120. In other embodiments, apertures 13, 14 and 15 may not be present, but other attachment means such as clips, clamps, springs, brackets, pressure devices, adhesives, contouring, fitting and single molding processes may be used.

In the exemplary embodiment shown, when assembled, lens rim 11 fits over the exterior of traffic signal light visor 120, and lens rim bolts 13a, 14a, 15a bind through apertures 13, 14, 15 (not shown) and are secured by lens rim bolt nuts 13b, 14b, 15b. In various embodiments lens rim 11 may be secured to traffic signal light visor 120 by other attachment means including but not limited to as clips, clamps, springs, pressure devices, adhesives, contouring, fitting, brackets, single molding processes or any other attachment devices or processes known in the art.

In the exemplary embodiment shown in FIG. 1, dome lens surface 10 has an arc length of α, which corresponds and/or is proportional to the arc length of the refracting lens surface (not shown), where arc length of both dome lens surface 10 and refracting lens surface 130 are calculated by the equation:

$$Arc Length = R ( \frac{2 π C}{360} ) ,$$

where C is the central angle of the arc of a lens in degrees, R is the radius of the arc of a lens, and π is Pi, approximately 3.142. A central angle may be determined by taking any angle whose vertex is the center of a circle, and whose sides pass through a pair of points on the circle.

The arc of the dome lens surface 10 will be larger than the arc length of refracting lens surface 130 to allow placement of snow deflecting traffic signal light apparatus 100 over traffic signal light visor 120 while enabling dome lens surface 10 to fit securely over traffic signal light visor 120 and to accommodate the thickness of lens rim 11.

For example, in the exemplary embodiment shown, traffic signal light visor 120 (which is a tunnel visor) has an outer diameter d of 11⅛ inches to accommodate a 12 LED lens, but in other embodiments, d may be any diameter. For example, dᵥᵢₛₒᵣ may be varied to accommodate a traffic signal having an 8 inch refracting lens 130 (or any other size)

In the exemplary embodiment shown, lens rim 11 has inner rim surface 11a (not shown) and an upper rim 11b (not shown). In the embodiment shown, the diameter of the rim dᵣᵢₘ measured at the inner rim surface is 11 5/16 inches to accommodate a 12 inch visor, but in various embodiments may be of any size. For example, dᵣᵢₘ may be varied to accommodate an 8 inch visor (or any other size).

In the exemplary embodiment illustrated in FIG. 1, traffic signal light visor 120 is a “12 inch” plastic visor, which is required by code and known in the art, and may have size variations due to material, manufacturing or other factors. Slight variations in size due to material, manufacturing and other factors will not prevent a visor from being referred to as a “12 inch visor” as known in the art.

In various embodiments, traffic signal light visor 120 and arc length of dome lens surface 10 may be engineered to any diameter.

Also shown in FIG. 1 is optional water repellent substrate 12. In the exemplary embodiment shown in FIG. 1, water repellent substrate 12 is an additional layer affixed to the exterior surface of dome lens surface 10. Water repellent substrate 12 may be made of any material known in the art to repel water and not interfere with the color or visibility of an LED traffic signal light, such as silica. In still further embodiments, dome lens surface 10 may contain additional layers for weather-proofing and preventing light reflection and refraction. In yet further embodiments, dome lens surface 10 may contain additional weather-proofing and reflection/refraction preventing treatments, including treatment with a chemical spray to increase water repelling properties of the dome lens surface 10. For example, dome lens surface 10 may be treated with a polysiloxanate-based water repellent chemical spray to increase the weather-proofing of dome lens surface 10. For example, the commercially product Rain-X™ or any other commercially available product may be utilized.

Dome lens surface 10 may also be treated to be UV stabilized. UV stabilization means that the material of dome lens surface 10 will not fade, warp or otherwise degrade as a result of being exposed to UV light from the sun.

The exemplary embodiment shown in FIG. 1 uses attachment means such as lens rim bolts and lens rim bolt nuts to attach snow deflecting traffic signal light apparatus 100 to traffic signal light visor 120. However, in further exemplary embodiments, snow deflecting traffic signal light apparatus 100 may be attached to traffic signal light visor 120 by nails, screws, bolt/nut assemblies, stainless steel bolt/nut assemblies, clips, clasps, spring protuberances, gaskets, adhesives, brackets and any other means known in the art to secure such structures.

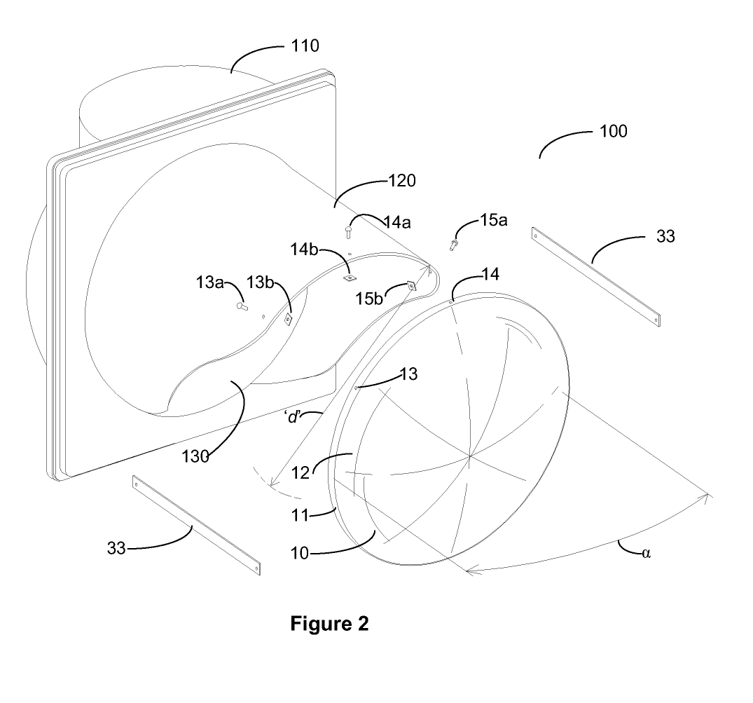

FIG. 2 illustrates an exemplary embodiment of snow deflecting traffic signal light apparatus 100 in use on an alternative style of LED traffic signal light. In the exemplary embodiment shown in FIG. 2, traffic signal light assembly 110 includes traffic signal light visor 120, which is a cutaway visor. Visor 120 protects refracting lens 130. Dome lens surface 10 is shown joined lens rim 11, which contains apertures 13, 14, 15 (not shown) in alignment with apertures in traffic signal light visor 120. Lens rim 11 is adapted to fit over the exterior of traffic signal light visor 120, and affixes to traffic signal light visor 120 with the lens rim bolt/lens rim bolt nuts (13a, 13b, 14a, 14b, 15a, 15b) as described with FIG. 1. Also shown in the exemplary embodiment illustrated in FIG. 2 is optional bracket assembly 33, which is adapted to provide additional support to hold lens rim 11 to visor 120. In still other embodiments, alternate attachment means, such as nails, screws, brackets, adhesives, single molding processes, clasps, clips and other attachment means known in the art may be used.

As shown in FIGS. 1 and 2, it is possible to manufacture snow deflecting traffic signal light apparatus 100 such that apertures 13, 14, 15 are in identical locations with identical spacing such that the same snow deflecting light apparatus 100 may be used with both traffic signal light tunnel visor assemblies and traffic signal light cutaway visor assemblies. However, in other embodiments, apertures or other attachment means may be unevenly spaced, machined, molded or otherwise placed. In other embodiments, optional bracket 33 may also be used to secure a visor, such as cutaway visor.

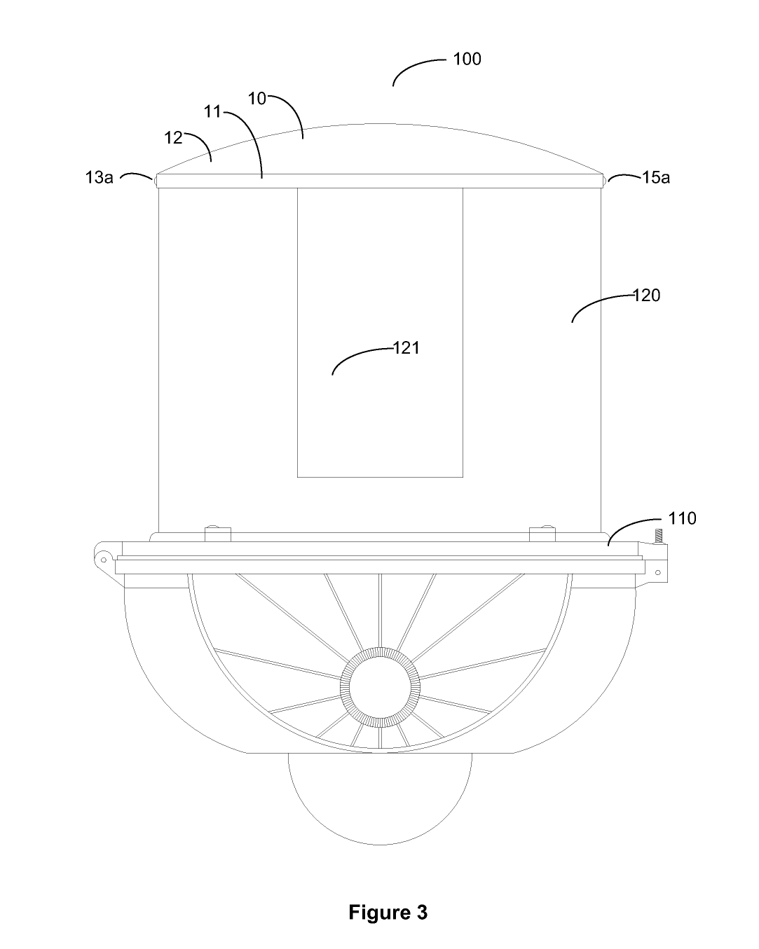

FIG. 3 is a bottom view of snow deflecting traffic signal light apparatus 100. Traffic signal light assembly 110 contains traffic signal light visor 120, which in the embodiment shown is a tunnel visor with cutaway portion 121. However, as illustrated with the exemplary embodiment shown in FIG. 2, traffic signal light assembly 110 may contain a cutaway visor instead. Dome lens surface 10 is showed as dome-shaped, with lens rim 11 overlapping on the exterior of traffic signal light visor 120. Visible on the exterior of lens rim 11 are the heads of lens rim bolts 13a, 15a.

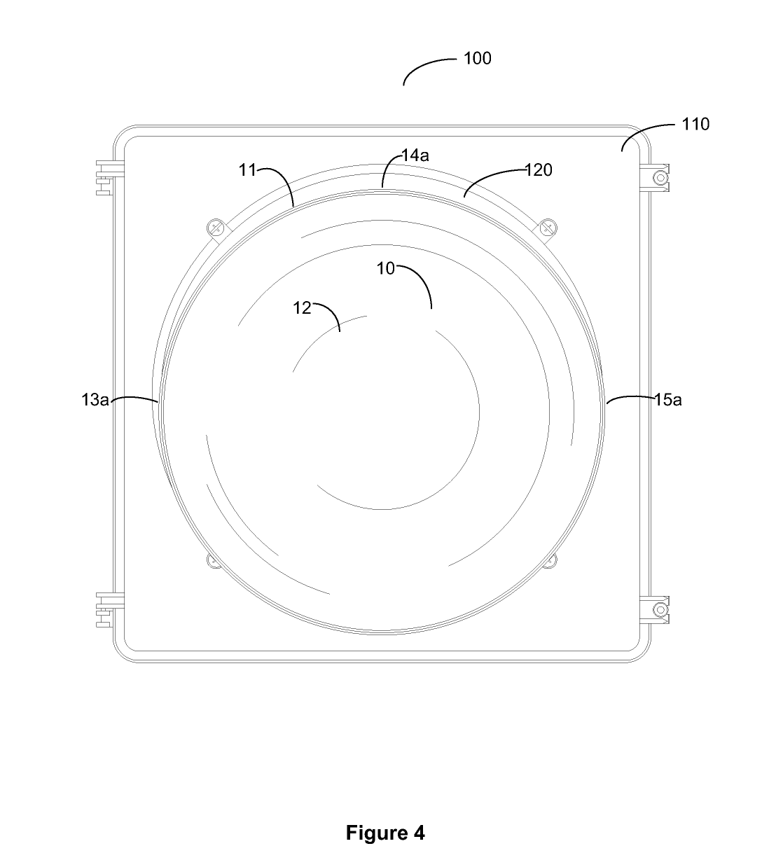

FIG. 4 is a front view of an exemplary snow deflecting traffic signal light apparatus 100. Dome lens surface 10 is directly in line with traffic signal light visor 120, such that lens rim 11 is barely visible behind dome lens surface 10. The heads of lens rim bolts 13a, 14a, 15a are not visible from the front of snow deflecting traffic signal light apparatus 100.

In further exemplary embodiments, lens rim 11 may be of different thicknesses.

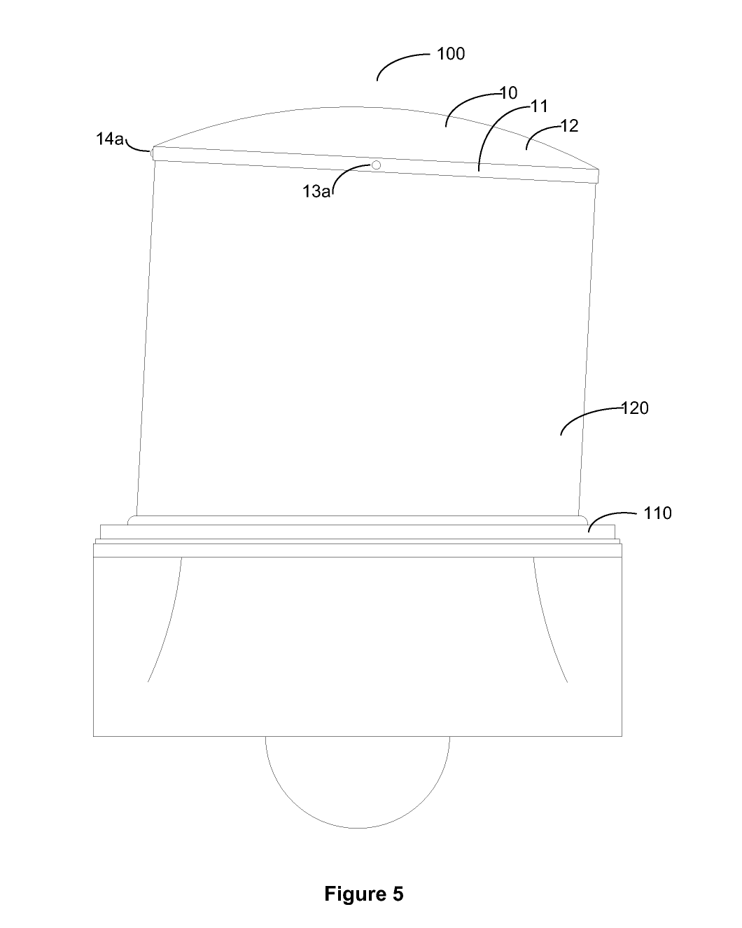

FIG. 5 is a side view of an exemplary embodiment of snow deflecting traffic signal light apparatus 100. Traffic signal light assembly 110 contains traffic signal light visor 120, which in this exemplary embodiment is a tunnel visor. Dome lens surface 10 is dome-shaped, and lens rim 11 projects over the exterior of traffic signal light visor 120. The heads of lens rim bolts 13a, 14a are visible projecting over lens rim 11. In still further exemplary embodiments, lens rim bolts may be adapted to be flush with lens rim 11 when snow deflecting traffic signal light apparatus 100 is assembled.

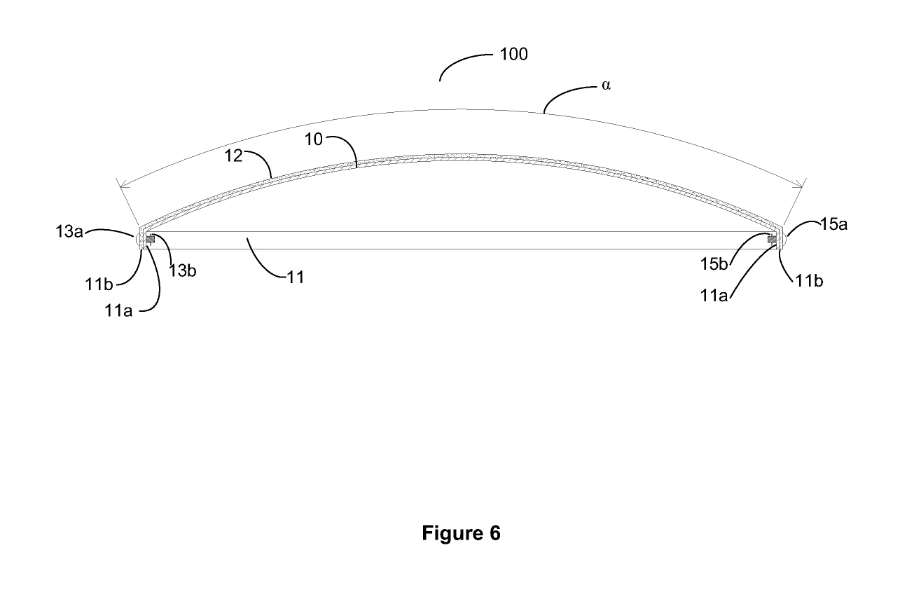

FIG. 6 illustrates a sectional view of dome lens surface 10 with lens rim 11 of an exemplary embodiment of snow deflecting traffic signal light apparatus 100. Dome lens surface 10 is dome-shaped, which is critical to deflecting snow and other forms of precipitation. Dome lens surface 10 and lens rim 11 also contain an additional water repellent substrate layer 12. In the exemplary embodiment shown in FIG. 6, dome lens surface 10 and water repellent substrate 12 are fixedly joined or molded as a single unit, with snow deflecting traffic signal light apparatus 100. In still further exemplary embodiments, snow deflecting traffic signal light apparatus 100 may be made include additional layers for weather-proofing or to prevent light reflection and refraction.

Also shown in FIG. 6 are assembled lens rim bolts/lens rim bolt nuts 13a, 13b, 15a, 15b. Lens rim bolts 13a, 15a extend through lens rim 11, which includes dome lens surface 10 and water repellent substrate 12 layer. Lens rim bolt nuts 13b, 15b wind onto lens rim bolts 13a, 15a to secure lens rim 11 and snow deflecting traffic signal light apparatus 100 to traffic signal light visor 120.

In the exemplary embodiment shown, lens rim 11 has inner rim surface 11a and an upper rim 11b. In various embodiments, inner rim surface 11a may be a different size or length, and upper rim 11b may be of different thicknesses, depending on the visor or light to which snow deflecting traffic signal light apparatus 100 will be attached.

What is claimed is:

1. A snow deflecting LED traffic signal light apparatus comprised of:
a power supply board which converts 120 volts AC to 12 volts\DC;
a housing which encases said power supply board;
at least one LED positioned behind a refracting lens, said refracting lens having a first arc length;
at least one dome attachment member;
a visor with an outer diameter; and
a dome lens having a rim portion, at least one aperture, an inner diameter and a second arc length which corresponds to said first arc length of said refracting lens.

2. The apparatus of claim 1 wherein said visor includes a ventilating opening.

3. The apparatus of claim 1 wherein said visor is a molded traffic signal light tunnel visor.

4. The apparatus of claim 1 wherein said refracting lens is a 12 inch lens and said second arc length and said inner diameter are adapted to cover a 12 inch visor.

5. The apparatus of claim 1 wherein said inner diameter is between 180 and 350 millimeters.

6. The apparatus of claim 1 wherein said second arc length is greater than said first arc length, when said first arc length and said second arc length are taken at corresponding angles.

7. The apparatus of claim 1 wherein said visor is a traffic signal light cutaway visor.

8. The apparatus of claim 1 wherein said dome lens further water resistant substrate layer.

9. The apparatus of claim 1 which further includes a silica-based water resistant substrate layer affixed to said dome lens.

10. The apparatus of claim 1 wherein said dome lens is treated with a water repellent chemical spray.

11. The apparatus of claim 1 wherein said dome lens is treated with a water repellent polysiloxanate-based chemical spray.

12. The apparatus of claim 1 wherein said dome lens is treated with a UV stabilizing chemical.

13. The apparatus of claim 1 wherein said refracting lens is an 8 inch lens and said second arc length and said inner diameter are adapted to cover an 8 inch visor.

14. The apparatus of claim 1 wherein said at least one dome attachment member is selected from the group consisting of a screw, a bracket, a bolt, a hinge, a pin, a clasp, a clip, a spring, a pressure device, a gasket, a fitting, a contour, a single molding, an adhesive and combinations thereof.

15. A snow deflecting LED traffic signal light apparatus comprised of:
a dome having an arc length which is proportionate to the arc length of the refracting lens of a traffic signal light assembly;
a rim which encircles said dome having a diameter greater than the diameter of the visor of a traffic signal light assembly such that the interior surface of said rim overlaps the exterior surface of said visor;
a plurality of apertures through said rim; and
a plurality of attachment members adapted to engage said plurality of apertures and affix said rim to said visor.

16. The apparatus of claim 15 wherein said plurality of attachment members is selected from the group consisting of a screw, a bracket, a bolt, a hinge, a pin, a clasp, a clip, a spring, a pressure device, a gasket, a fitting, a contour, a single molding, an adhesive and combinations thereof.

17. The apparatus of claim 15 wherein said visor is selected from the group consisting of a traffic signal light cutaway visor and a molded traffic signal light tunnel visor.

18. The apparatus of claim 15 wherein said refracting lens is an 8 inch lens and said second arc length and said inner diameter are adapted to cover an 8 inch visor.

19. The apparatus of claim 15 wherein said refracting lens is an 12 inch lens and said second arc length and said inner diameter are adapted to cover an 12 inch visor.

20. The apparatus of claim 15 wherein said dome lens further includes at least one treatment selected from the group consisting of a water repellent substrate layer, a silica water repellent substrate layer, a water repellent chemical spray, a polysiloxanate-based chemical spray, a UV stabilizing treatment, and combinations thereof.
